(19) United States
(12) Patent Application Publication
(10) Pub. No.: US 2015/0141133 A1
(43) Pub. Date: May 21, 2015

(54) BETTING METHOD AND SYSTEM

(71) Applicant: INPLAYRS LTD, London (GB)

(72) Inventors: Anil BHAGCHANDANI, London (GB); David BEESLEY, London (GB)

(21) Appl. No.: 14/550,319

(22) Filed: Nov. 21, 2014

Related U.S. Application Data
(60) Provisional application No. 61/907,144, filed on Nov. 21, 2013.

(51) Int. Cl. G07F 17/32

(52) U.S. Cl. CPC G07F 17/3244; G07F 17/3276; G07F 17/3288
USPC 463/26

(57) ABSTRACT

The present invention relates to a computer-implemented method of providing a game within a communications network comprising a plurality of devices and at least one server. The method includes the steps of at least one player of a plurality of players within a pool selecting an outcome for an event at a device; the server accumulating points for the player, wherein the points are calculated based upon odds for the outcome at the time of selection; and the server determining the winning player or players for the pool based upon accumulated points. A further method involving a pool of pools, a system, and a computer medium are also disclosed.

### FIELD OF INVENTION

The present invention is in the field of betting. In particular, but not exclusively, the present invention relates to providing a betting game within a communications network.

### BACKGROUND

At the basic level, betting is about making one or more predictions on the outcome of events, and getting rewarded if the predictions come true. Most betting occurs around the world of sports, but can equally be applied to any event which has a defined outcome.

At present, there are two types of widely recognized and deployed betting systems.

The first betting system is pools betting (also called pari-mutuel). In this kind of betting, a series of predictions are presented to a user. The user selects those predictions which become the user's entry, along with an amount to stake. A certain amount is removed by the operator of the game and the remaining quantity is divided by winning entries. Pools are either public (available to anyone) or private (closed to certain individuals, for example, friends or colleagues).

Traditional pools betting is prevalent throughout the world with each country often having its own system covering various events.

In the last 30 years, two new offshoots from pools betting have gained popularity. The first is tournaments. The best example of this is the NCAA basketball tournament, but there are others like Football World Cup, poker tournaments, etc. In the case of NCAA, users fill out a bracket before the start of the tournament and make all their predictions, points are awarded on a scale (1 point for 1st round match, 2 points for second round, and so forth), and users' entries are submitted into public or private pools. Entries with the most points are declared winners. The other type is fantasy sports where users pick players from various teams (such as NFL football) and are awarded points based on their players' performance during real matches. Players are picked using various methods (such as draft or based on a budget), and points are also awarded using various systems. Generally users pick players at the start but they're allowed to make substitutions from time to time. Each “virtual team” then is entered into a pool, public or private, or sometimes Head to Head, and the top score(s) win.

The disadvantages of pools betting are as follows:
1. Most games require the user to make their selections at the start with very little interaction as the weekend, week, or season progresses.
2. The same users tend to win consistently leading to a lack of broad engagement. Also due to high takeouts, pools betting is generally not very competitive.
3. Many games (especially with private pools) require lots of setup and admin and aren't particularly suited for mobile devices.
4. Games require lots of liquidity. And as payouts are determined by how many other people are playing and what they select, users don't actually know what the odds are or what they stand to win at the start. Hence games are not dynamic and don't reflect real probabilities.

The other betting system is fixed odds. In this system a user bets on an event (e.g. Team A to win) and agrees an amount and a price with another entity. That entity could be a bookmaker, another user, or someone else. Generally those prices (or odds) are widely advertised and a bookmaker creates a book with an overround. Unlike pools betting, fixed odds involves some risk and transactions are one to one.

The disadvantages of fixed odds betting are as follows:
1. Not very social and no real element of a group, as your bet is with one other entity.
2. Because of margins and overrounds, bookmakers tend to win over time, so an end user doesn't have a fair chance.
3. While pools betting is generally legal and regulated by governments, online fixed odds betting is largely illegal in most parts of the world.

It is an object of the present invention to provide a betting game which overcomes, at least some, disadvantages of the prior art, or at least provides a useful alternative.

### SUMMARY OF INVENTION

According to a first aspect of the invention there is provided a computer-implemented method of providing a game within a communications network comprising a plurality of devices and at least one server, including the steps of:
a) at least one player of a plurality of players within a pool selecting an outcome for an event at a device;
b) the server accumulating points for the player, wherein the points are calculated based upon odds for the outcome at the time of selection; and
c) the server determining the winning player or players for the pool based upon accumulated points.

The odds may change over a time period, and the player may select the outcome during the time period. The time period may include, at least, a portion of the event time.

The player may change their outcome selection during the time period and may accumulate points which are calculated based upon the difference in odds between initially selected result at the time of selection and the new result at the time of changed selection.

The player may bank the outcome during the time period and accumulate points which are calculated based upon the difference in odds at the time of selection and the time of banking.

One or more players may select outcomes across a plurality of events. A winner or winners for the plurality of events is determined based upon points

The outcomes may be selected from a plurality of options.

The odds for the outcome may be normalised from odds compiled using an overround. The odds for the outcome may be calculated based upon a plurality of odds for the result.

The player may accumulate points if the selected outcome occurs.

The device may display a plurality of outcomes for one or more events and possible points to accumulate in relation to each outcome prior to selection of an outcome by the player. The device may display possible points changing over time in response to the change in odds. A single action at the device from the player may confirm selection of the plurality of outcomes.

When the selection of the outcome is made during the portion of event time the points may be calculated based upon the odds utilising a decay function, such that the points decrease during the portion of event time.

The player may be allocated to the pool automatically.

According to a further aspect of the invention there is provided a computer-implemented method of providing a game within a communications network comprising a plurality of devices and a server, including the steps of:
a) each player of a plurality of players within one of a plurality of pools selecting an outcome for an event at a device;
b) the server accumulating points for each player based upon their selection;
c) the server totalling the points for a selection of players within each pool; and
d) the server allocating winnings across the pool with the largest points total for the selection.

According to a further aspect of the invention there is provided a system for providing a game, including:
a plurality of devices;
one or more servers; and
a communications network;
   wherein the system is configured for providing the method of either of the preceding aspects.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a flowchart illustrating a method in accordance with an embodiment of the invention;

FIG. 2: shows a flowchart illustrating a method in accordance with an embodiment of the invention;

FIG. 3: shows a block diagram illustrating a system in accordance with an embodiment of the invention; and

FIGS. 4 to 17: show diagrams illustrating an embodiment of the present invention.

### DETAILED DESCRIPTION OF PREFERRED EMBODIMENTS

The present invention relates to a method and system for providing a betting game.

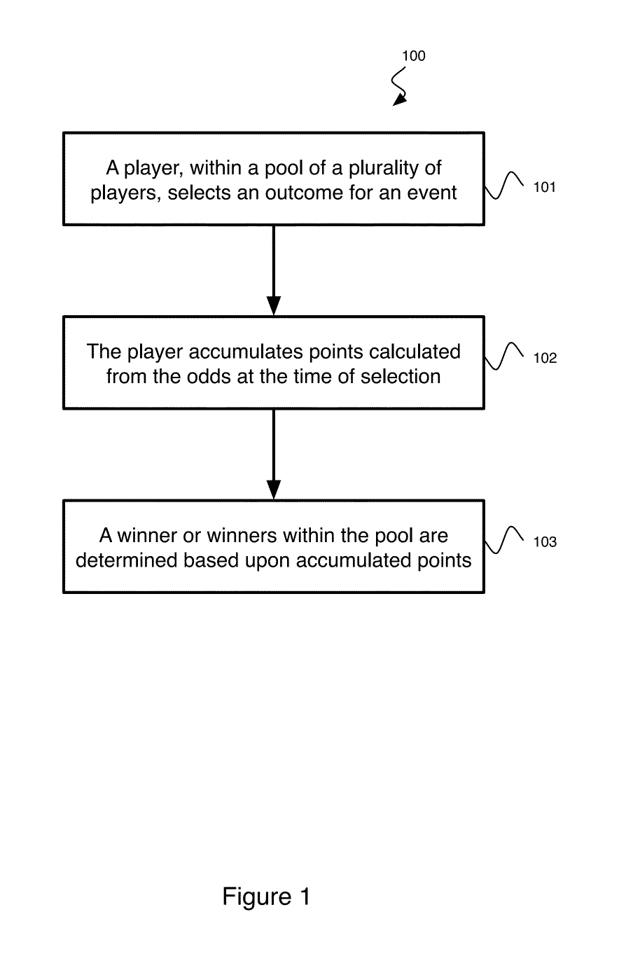

In one embodiment 100 shown in FIG. 1, the method involves players selecting outcomes for an event in step 101. If the outcomes eventuate, the players accumulate points based upon the odds of those outcomes occurring in step 102.

The event may be which team or individual wins a game or part of a game, or which team or individual scores a specific point or points, or reaches a specific points level, or any type of event within any type of sport or activity.

The players may select outcomes at a client device such as a mobile device or other computing apparatus. Possible outcomes for an event may be displayed at the client device. The points that may be accumulated may also be displayed in conjunction with each outcome. This may, for example, assist or incentivise players to make decisions about which outcome to select. In one embodiment, outcomes (and points) for a plurality of events may be displayed. The events may be related, for example, events occurring in a specific competition during one week. In one embodiment, the player may identify outcomes for a plurality of events and effect the entire selection by actuation of a single input at the client device, for example, by pressing a button within a graphical user interface displayed at the client device. This button may also update the points within the graphical user interface.

The points that may be accumulated may be calculated based upon the time of selection of the outcome. For example, odds may be obtained from one or more sources for the outcome continuously or periodically. These odds may be normalised and/or processed and points may be calculated from these odds. For example, the source or sources of the odds may include an over-round and these odds may be processed to remove the over-round before the points are calculated. When the player selects the outcome, the points that will be accumulated by that player if the outcome eventuates will the points calculated from the odds at the time of selection. These points may be displayed to the player within a graphical user interface at the client device before selection, to assist the player in making a decision on selection.

The outcomes may be selectable by the player during a period of time. The end of this period of time may be defined by when the event occurs or at the beginning of a time period related to the event (an event time period). This event time period may be, for example, the beginning of a game to which the event relates.

During the event time period, the points may be calculated based upon both the odds and a decay curve, such that the value of the points decreases during the period.

In one embodiment, during the time period the player may choose to “bank” their outcome. That is, the player may bank their outcome and be awarded the difference in points calculated at the time they selected the outcome and the points calculated at the time they banked the outcome. This difference may be displayed to the player at a client device in relation to the event prior to banking to enable the player to bank or not. In one embodiment, the player may reselect a new outcome.

Those points can be used to determine a winner or winners for an event in step 103, for a game (a collection of related events—i.e. Liverpool v Arsenal), for a competition (a collection of related games—i.e. Premier League), or within a category of competitions or games (i.e. football).

The winner or winners can be determined within a pool of players which may comprise anywhere from two players (head to head) to many players.

The pool of players can be a global pool, or one of a plurality of pools, such as a pool comprised of friends or fans (for example, fans of a particular team).

In one embodiment, players may be automatically added to one or more pools. In another embodiment, the player may choose to play “head to head” and the other player may be automatically selected for the “head to head” based upon which players have selected outcomes for the same event or events (i.e. possible players). Within this group of possible players, priority for selecting the other player may be based upon selection first from friends and/or then selection from a fangroup opposing a fangroup of the player.

For example, player A may select the outcome of Arsenal scoring two goals against Liverpool. At the time of selection, points may be calculated based upon odds generated for that outcome. The odds may be quite low and, therefore, the points to be awarded may be quite high—30 points. Player B may select the same outcome, but during the game and when Arsenal have already scored one goal. In this circumstance, the odds will have changed and become more likely, and the points to be awarded will be lower—20 points. If Arsenal ultimately scores two goals in the Liverpool v Arsenal game, player A accumulates 30 points and player B accumulates 20 points. If player A is playing head to head with player B, player A may be determined to be the winner.

The points that are calculated may be calculated based upon the odds and a stake wagered by the player. In one embodiment, the stake wagered is predefined for all players.

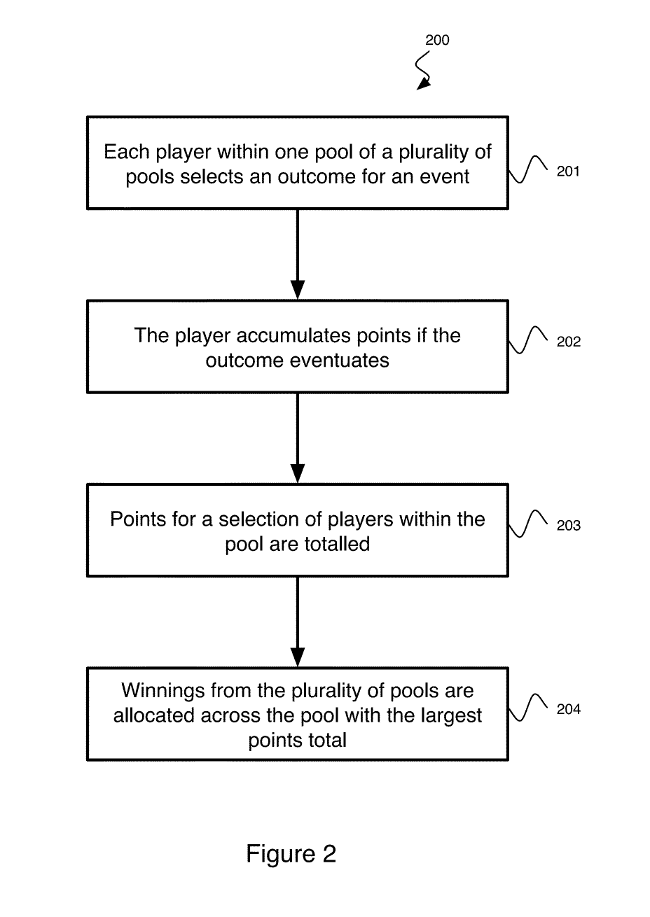

In another embodiment 200 shown within FIG. 2, players within pools select outcomes for an event in step 201 and accumulate points if the outcomes eventuate in step 202. Points for a selection of players within the pool are totalled in step 203. And winnings from the pools are allocated across the pool with the largest points total in step 204.

The selection of players may be the entire pool, or a portion of the pool. For example, the portion of the pools may be selected as a percentage of the highest points scorers.

As for above, the accumulated points can relate to an event, a game, a competition, or a category.

For example, if pool A accumulates “350” points during the Premier League competition and pool B accumulates “500” points during the Premier League, pool B is allocated the winnings.

In alternative embodiments, winnings are allocated to the single pool also based upon the distribution of accumulated points. For example, in one embodiment, if pool A has “10” players and pool B “20” players, pool A would be allocated the winnings based upon its per player average points of “35” to pool B's “25”.

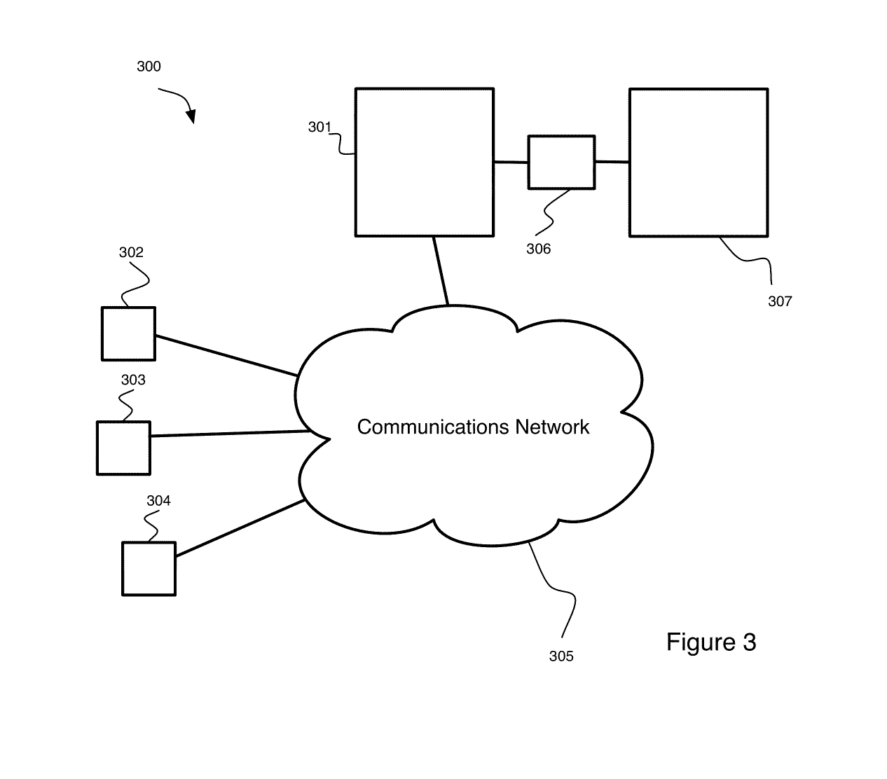

In FIG. 3, a system 300 in accordance with an embodiment of the invention is shown.

A first server 301 is shown. The first server 301 may be configured for transmitting possible outcomes for events to a plurality of clients 302, 303, and 304, for receiving selections of outcomes from the clients 302, 303, and 304, for calculating points for those selections based on odds for the selected outcomes at the time the outcomes were selected, for accumulating those points for a player account if the outcomes occur, and for determining a winning player account or accounts based upon the accumulated points.

A plurality of clients 302, 303, and 304 are shown. Each client may be configured for displaying a plurality of possible outcomes for an event to a user (a player), for receiving selections of an outcome from the user, and to transmit the selection to the first server.

The player may be associated with a player account at the first server 301.

The first server 301 may be configured to communicate with the plurality of clients 302, 303, and 304 via a communications network 305.

The clients 302, 303, and 304 may be computing devices, such as desktop computers or laptops, or handheld computing devices such as smart-phones, or tablet devices.

A database 306 is shown. The database 306 may store odds calculated over a time period for outcomes for events. The first server 301 may be configured to retrieve the odds from the database 306.

A second server 307 is shown. The second server 307 may be configured for processing odds for outcomes for events and storing those odds within the database 306. The second server 307 may be connected to one or more systems to retrieve one or more for each outcome. The second server 307 may be configured to process the one or more odds to generate singular normalised odds for each outcome.

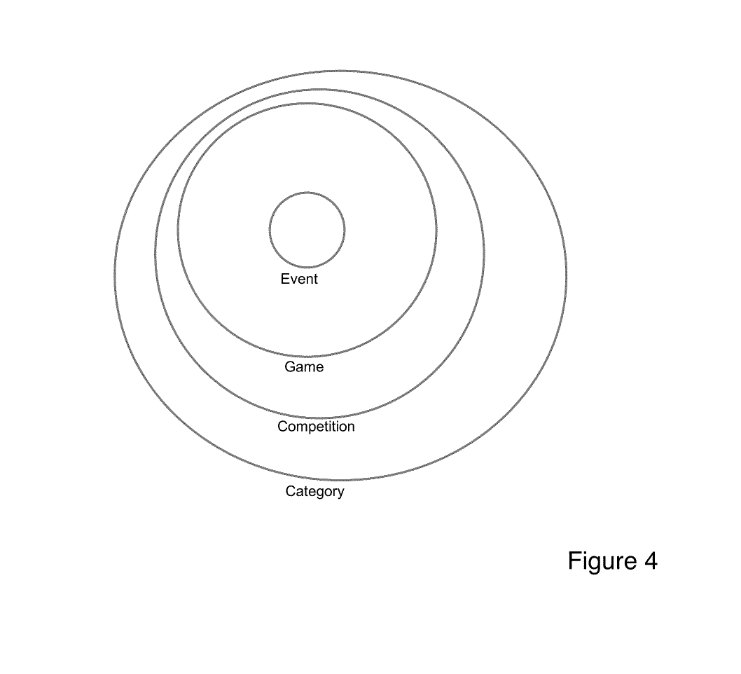

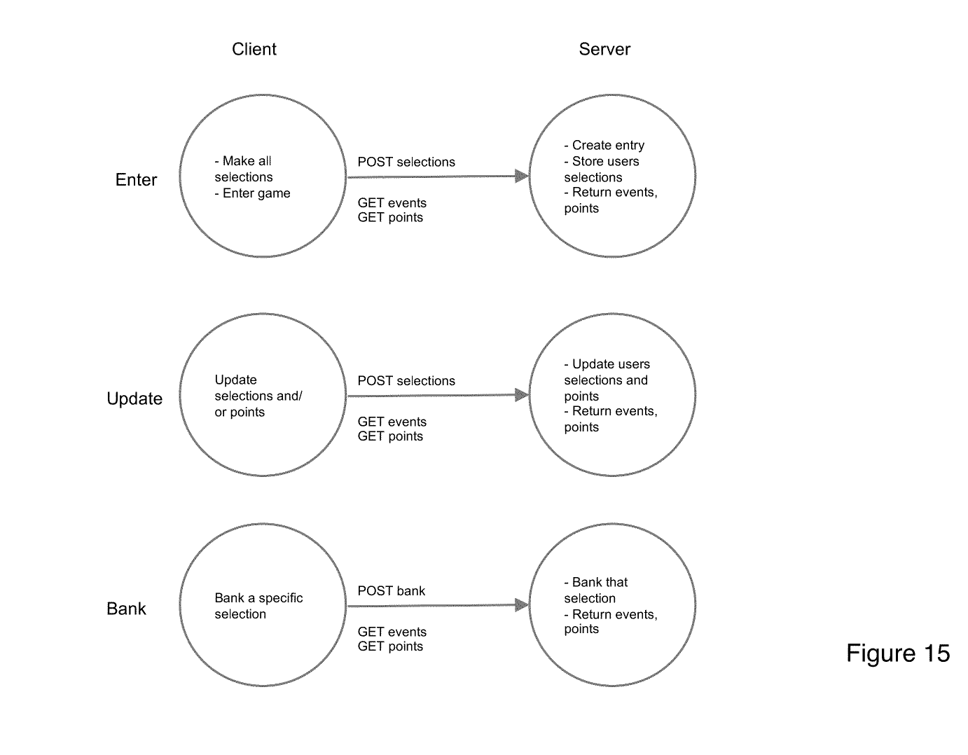

One embodiment of the present invention will now be described with reference to FIGS. 4 to 17.

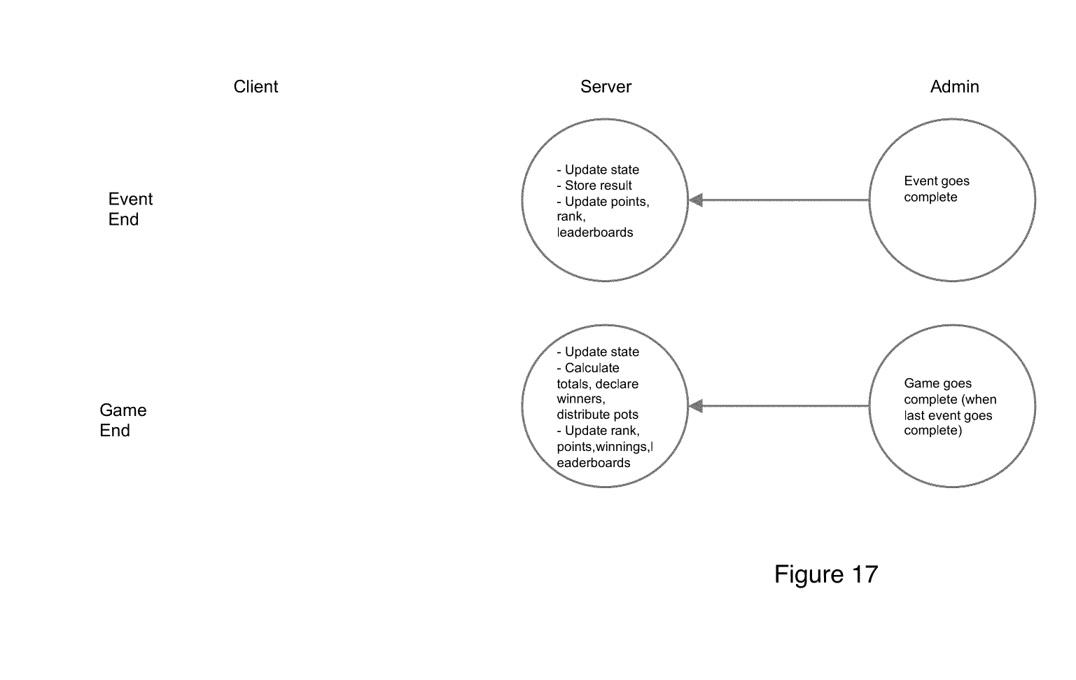

This embodiment will describe in further detail the method of betting above which will be termed dynamic pools betting in relation to FIGS. 4 and 17. In dynamic pools betting, users make predictions for a series of grouped events. They earn points based on the probabilities of those event outcomes. Points are then added up and the user who gets the most points wins the game. Entries can be submitted into a number of pools and cash awarded for each game. Games are also grouped into competitions and the user with the most cash at the end of the competition wins it. Points change throughout the game (until the event outcome is declared) allowing a user to update points or change selections throughout the game.

### Game Setup

At the most basic level, a user makes a prediction on an event. An event may be any activity with defined options and outcomes. Examples:
Who will win the match (team A or team B, player A or player B)?
What will be the outcome of a match (home, draw, away)?
Will Player A score (yes or no)?
How will this stock index fare today (up, down/same)?
Will Contestant A make it thru the next round (yes or no)?
How will Player A fare in the competition (win, top 3, 4+)?

The items in parentheses are the options, and there are a limited number of options (generally 2 or 3). However the main requirement is that all outcomes are captured by those options. These events are then grouped into a game, which is the basic unit of play. There can be 1 event or 100+ events in a game. However the optimal number is around 10 with the vast majority of games falling between 5 and 16 events. While the events can be arbitrarily grouped, they generally represent a round in a competition. For example:
10 premier league matches on the weekend
16 NFL matches in a given week
7 knockout matches in a tournament (4 quarter-finals, 2 semi-finals, 1 final)
Up to 5 sets in a tennis match, or 4 quarters in a basketball match
Up to 22 players on a football pitch who could possibly score

Games are then grouped into a competition. Generally this will follow the format of the underlying competition that is being played. Some examples:
Premier League has 38 weeks, so 38 games
NCAA tournament has 6 rounds, so 6 games

Finally each competition exists in a higher level grouping called a category. Generally this is the type of sport, or finance, politics, reality TV, weather, etc. Football, Basketball, Tennis, Finance are all categories. The relationship between these are illustrated in FIG. 4.

Competitions are also grouped by type. The vast majority of competitions fit into (but are not limited to) these 3 buckets:
1. Regular: a series of events grouped by round, over a defined period of time, like 90 minutes, a day, a week or weekend. NFL Regular Season and Premier League are examples.
2. Tournaments: knockout tournaments where players or teams advance by defeating opponents. NFL playoffs, Wimbledon tennis, and NCAA basketball are examples.
3. Stages: generally player based competitions where players advance thru rounds, with one player eventually winning. Reality TV, F1, Golf are examples.

Combinations may also be defined such as Football World Cup which is “Regular” during the Group Stage, then “Tournament” during the KnockOut Stage. In this case, two separate competitions may be offered or a combined competition may be offered.

Events can happen during a match. The difference is the period of time for the game outcome to be determined. So instead of a weekend or a week, it could be just 90 minutes. For example, which team will score next.

All competitions, games, and events exist in one of several states. For purposes of illustration, a game will be used as an example:
1. INACTIVE: game is currently not available and should not show up on the client;
2. PREPLAY: game is loaded with events and available for betting, no events have gone inplay;
3. TRANSITION: game is moving between states, for example between preplay and inplay;
4. INPLAY: game is inplay, which it will be from the time the first event goes inplay until the last event completes;
5. COMPLETED: game is completed, all events are done, and results have been calculated;
6. SUSPENDED: game is currently not available for betting, perhaps because prices aren't available; and
7. NEVERINPLAY: games won't be managed inplay, so users will not be able to bank or change their selection once the matches start; for example, when inplay price feeds are not available.

Games start and end at INACTIVE, so effectively run thru a loop. The typical loop for a game is: INACTIVE-PREPLAY-INPLAY-COMPLETED-INACTIVE. All these states also apply for events and competitions and have similar meanings.

### External Inputs

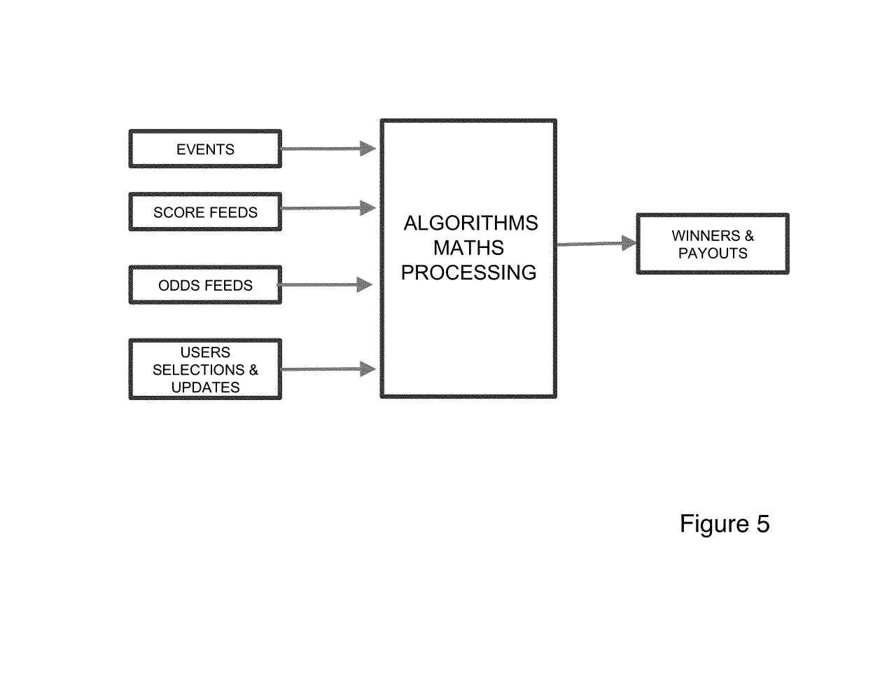

There are 3 external data sources required to run the system as shown in FIG. 5. An admin module processes and manages these inputs. The first input is a list of events, games, and competitions, and for each the following is required:
Name
Start Date/Time
Type
State

An example event might be:
Arsenal v Chelsea Sep. 4, 2013 HomeDrawAway PREPLAY

The second input is real time scoring data and includes:
a progress indicator, for example elapsed time in a match
the score (or whatever data is needed to evaluate which option is likely to win)
the result (this is effectively the outcome, and which option came true)

In one embodiment, only the last piece of information is required, and the other two are for informational purposes only. The other two may help show progress while events are inplay. In addition to these three data points, a near real-time update of event state changes may be required (though these can usually be derived from the other data).

The third input is an odds feed. Odds come in various forms like American odds, fractional odds, or decimal odds. Exemplarily, decimal odds will be used in the remainder of this description, but it will be appreciated that the described embodiment can be modified to utilize any other type of odds. Odds effectively represent the probability of an event happening. Odds are used to determine points and, because odds are constantly updating, users may be permitted to change their selections or update their points throughout preplay and inplay. Odds may come from a variety of sources. For example, an in-house odds compiler, or any number of external data providers. There may be many data points used to calculate odds, for example, with a football match:
the current strength of teams
the current strength of individual players and staff
past form (of teams, players)
the environment (weather, location, pitch, referees, crowd etc)
data from previous matches (for this team, for this league, for when these teams met etc)
activity on the pitch including goals, cards, possession, corners, shots, etc
the elapsed time

All this data may be compiled to generate the odds of a particular outcome happening. Generally the more reliable and accurate the data, the greater the chance of getting true probabilities. The following steps are performed for processing odds during preplay:
1. Retrieve a variety of sources of odds data (a single source is sufficient, but more sources may improve accuracy, reliability, and event coverage).
2. Select the best odds available.

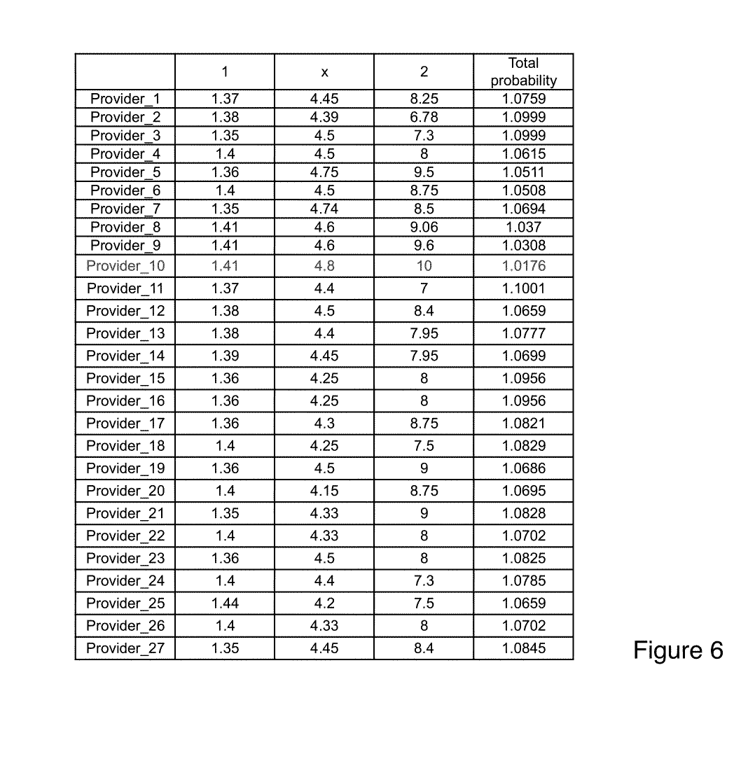

FIG. 6 shows odds from 27 different providers for a Premier League football match (Liverpool v Stoke City, Aug. 17, 2013) on a 3-way win market.

Normally odds providers have over-rounds on their sport book such that the total probability does not add up to 1 (as can be seen in FIG. 6 where the total probability has been determined using equation 1 below). Assuming the overround is equal across the runners we can normalize the odds to 1, effectively subtracting the overround. For example, provider_{—}1 has an overround of 0.0759 (1−1.0759) or 0.0253 per runner (0.0759/3). Equation 2 below converts the odds to probabilities, subtracts the overround and converts the probabilities back to odds.

Different methods of distributing the overround can be envisaged. For example, distributing the overround proportionately based on the odds.

$$\begin{matrix} Total\_prob = \frac{1}{{odds}_{1}} + \frac{1}{{odds}_{x}} + \frac{1}{{odds}_{2}} & Equation 1 \\ Corrected\_prob = \frac{1}{\frac{1}{{odds}_{1}} - ( \frac{\frac{1}{{odds}_{1}} + \frac{1}{{odds}_{x}} + \frac{1}{{odds}_{2}} - 1}{3} )} & Equation 2\end{matrix}$$

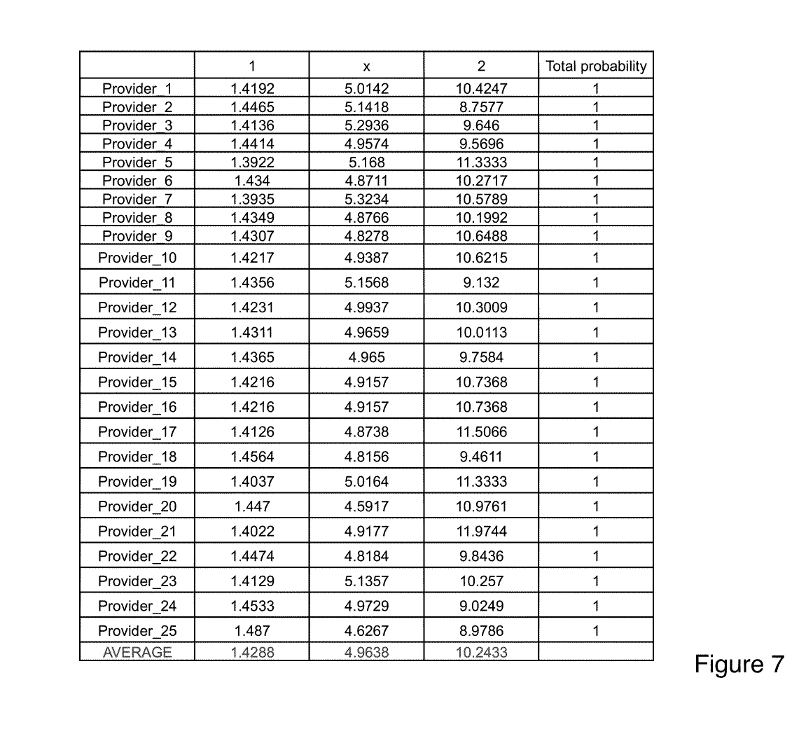

Odds selection can be divided as follows
A. Assuming a small overround in the odds (<1.03 for example) it is possible to just convert the odds straight to points
B. Normalise the odds from one provider using equation 2
C. For cases where multiple odds providers are available, the overround can be subtracted for each runner and averaged as shown in FIG. 7
3. Convert odds to points. Here for each event, exemplarily, a virtual $10 is bet at those odds, so by multiplying the odds by 10, results in the points. This may be rounded to whole numbers and a minimum of 11 points and a maximum of 500 points may be enforced. For example:
   Example 1 (normal):
   odds₁=1.37->points₁=14
   odds₂=4.45->points₂=45
   odds₃=8.25->points₃=83
   Example 2 (max points):
   odds₁=1.1->points₁=11
   odds₂=60->points₂=500 (max points)

To avoid a single player selecting all outsiders in the hope of ‘getting lucky’ and winning 500 points (for example, Nadal going out in the first round of Wimbledon) the maximum points may also be set as a multiple of the lowest available points for that game. For example, Nadal would have points of 11, setting a multiple of 20 would result in a maximum of 220, resulting in a more balanced distribution of risk and reward.
Example 3 (max multiple):
odds₁=1.1->points₁=11
odds₂=60->points₂=220 (max multiple)
4. Calculate points for each event. Here odds are transposed onto the event to fit the game format. For example, for each game type:

### (1) Regular

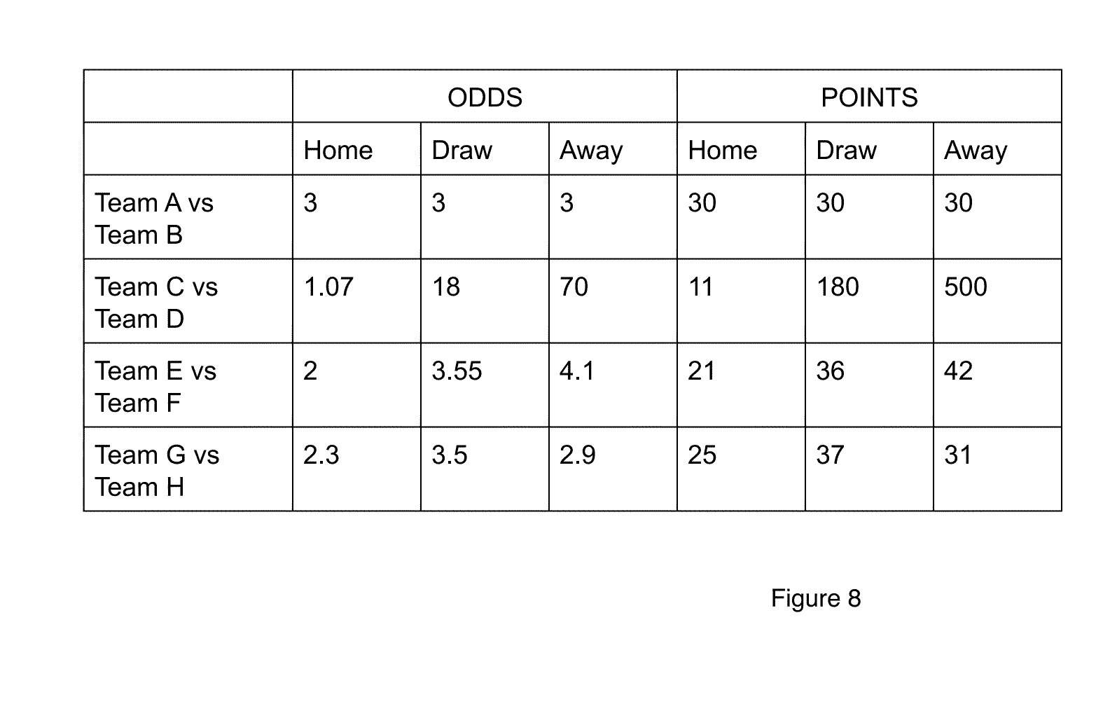

As shown in FIG. 8 the probability for each row adds up to 1. There is no dependency from one row to another as they are independent events. So the odds are retrieved from each market and converted directly to points.

### (2) Tournaments

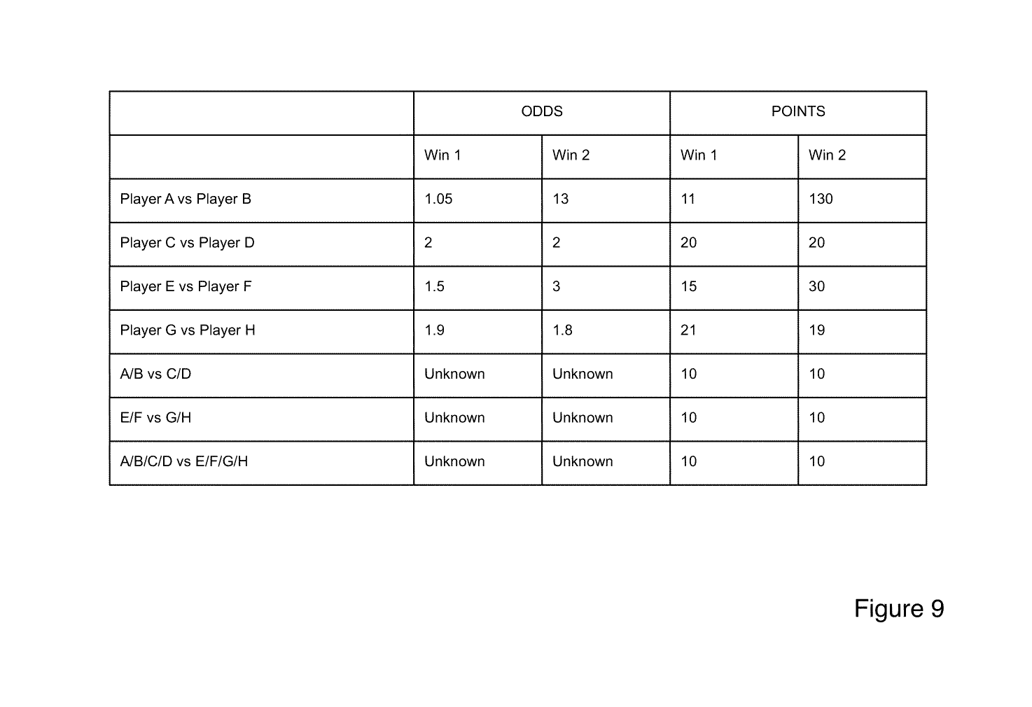

See FIG. 9. This example is similar to the above in the way the markets and odds transpose into points, but there are a few differences. First, there are players as the runners instead of teams. Second, there are only two options to choose from. Also while most games represent a round and each event is an independent entity, sometimes events may be added that are related (in this case later stages of the tournament). The example in FIG. 9 is a single elimination 8 person tournament with 4 quarter finals, 2 semi finals, and 1 final. All 7 matches may be grouped into one game. As the results are not known for the quarters, there are no odds available for the other matches, at the start of the tournament. However users may be required to select all 7 at the start to have a full entry. Odds of 10 may be given as a default as this effectively is the user getting their stake back and not taking a position. However as odds for those events get determined, the points on offer can be updated, and the user can update their points or selections. If the user forgets and does not update, then the starting price when the event goes inplay may be allocated to them, which will always be higher than 10.

### (3) Stages

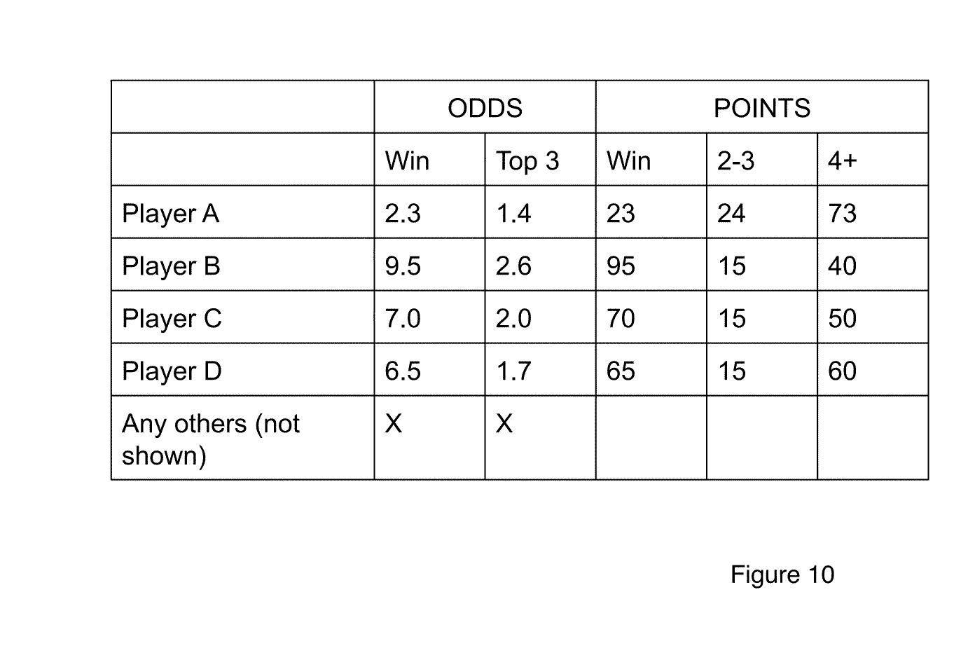

See FIG. 10. This kind of game is a bit more complicated than the others. In this case there are not individual markets for each event/row. Instead there are two overall markets which need to be processed and all points derived from that.

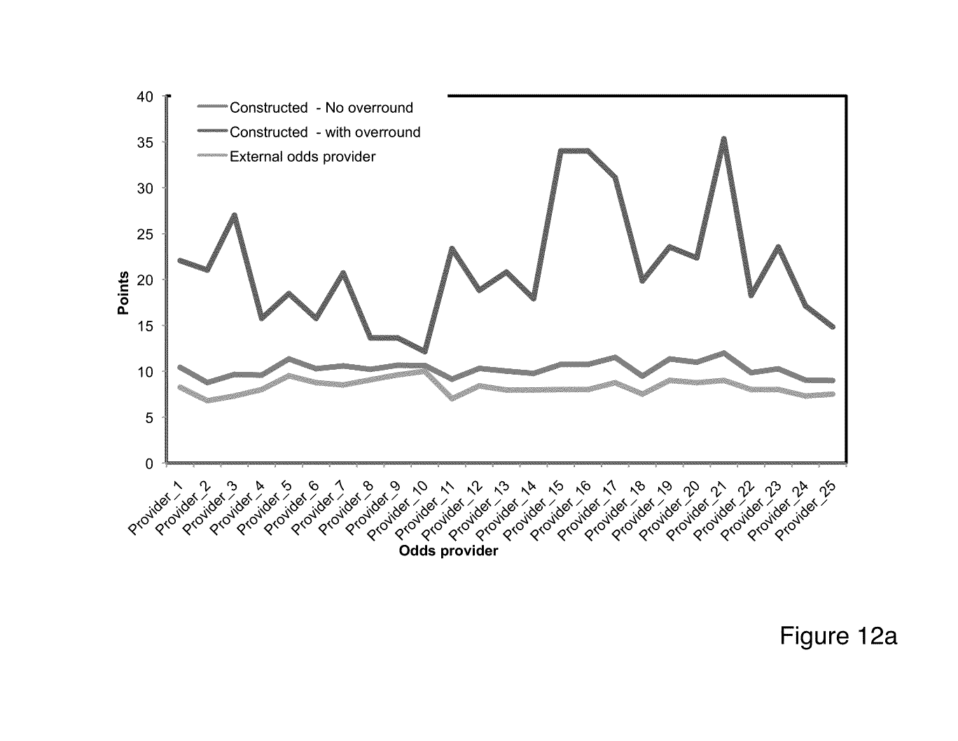

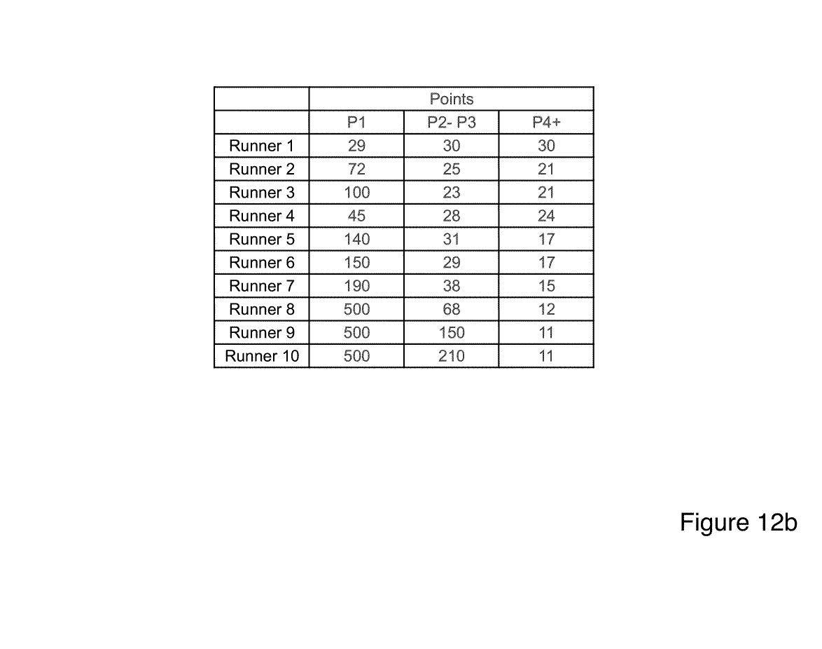

Notice these are individual player based, rather than one player or team challenging another. Typically the markets available from odds providers for stages games do not fit the game format of the present invention. As such the odds are constructed using two or more differing markets. For example F1 typically has a ‘winner market’ and a ‘podium market’ for all the runners racing that weekend. However instead of selecting just the 1st place finisher each runner may be treated as an array of options which are mutually exclusive (no overlap of options), such as 1st, 2-3 and 4+(see FIG. 12a).

The probability for the new market is constructed as follows using equation 3, where podium can be any market which includes the first win market.

$$P 2 and P 3 = \frac{1}{podium} - \frac{1}{win} \qquad Equation 3$$

position 1: winner market from odds provider
position 2-3: podium market-winner market

The remainder of the options available (4+) are determined by subtracting 1 from the sum of the total prob of the other markets. 4+ can be any market which includes the remainder of the options the runner can finish in.

$$4 += 1 - ( \frac{1}{win} + \frac{1}{P 2 - P 3} ) \qquad Equation 4$$

In this example, all runners must finish in one of the above positions, as such three finishing positions are possible for each runner. In this example, all rows/events are related and all events happen at the same time (so all will go inplay simultaneously). Also users can select as many wins, 2-3s, and 4+s as they want, but there will be exactly one runner who will win, 2 runners who will be 2 or 3, and the rest will be 4+.

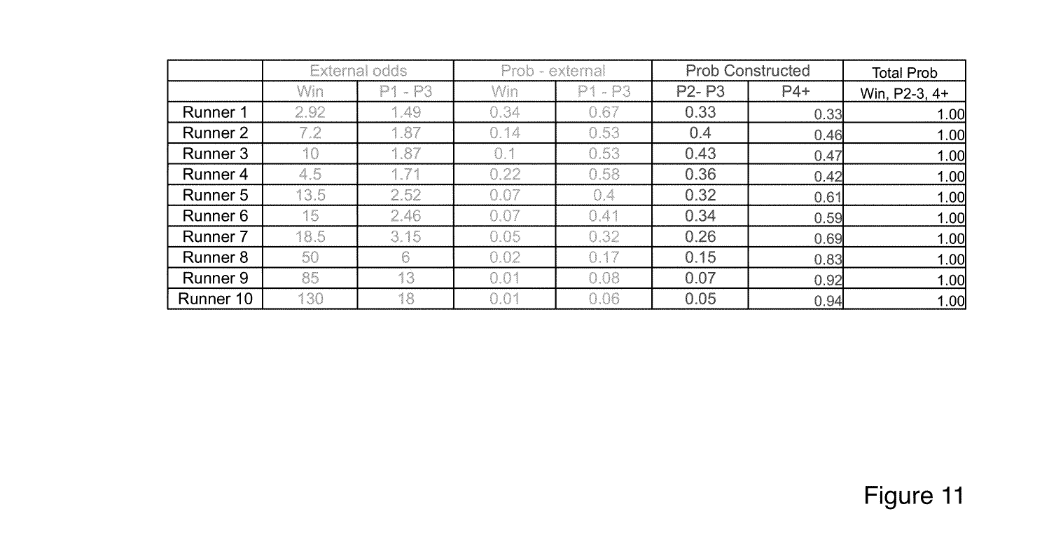

To illustrate this FIG. 11 shows two separate win and 1-3 (podium) markets from an external provider along with constructed odds for win 2-3 and 4+ which were determined using eq3 and 4 respectively. Each option now represents a mutually exclusive outcome, which must come true assuming the event completes. For this conversion to effectively work (although it is not strictly necessary) the overround should be removed from each market.

FIG. 12a demonstrates the requirement to remove the overround from a constructed market where one of the options within a market is unknown. The market shown is a Football ‘To Win’ market (where the options are win, lose and draw). The green line shows the external odds from 25 different odds providers for the lose option. While the blue and red lines represent an attempt to construct the lose option from the win and draw odds with (red) and without (blue) an overround. The constructed lose option was calculated using equation 4.

As can be seen the constructed odds with no overround (blue) closely match the odds from the external provider (green). While the constructed odds with an overround fluctuate based on the size of the overround from the external provider (red). Hence it can be asserted that constructing odds in this manner is both an effective way to simulate odds for unknown markets and the removal of the overround introduced by bookmakers enables true odds to be determined.

Points may then be calculated from FIG. 11 as shown in FIG. 12b.

The above explanation was about initializing and updating points before an event starts (preplay). This section explains how the points update during the match (inplay). There are at least two options.

The first is Bank. When an event goes inplay all the options are taken and the bank value is calculated. Users can then select bank and receive those points guaranteed regardless of the ultimate outcome. The formula for bank is:

(Original Odds/Current Odds)*Stake=Bank Value

Because each user already made a selection, only one bank value is shown (the one related to the odds of their selection). In its purest form, the bank value would be calculated for each user separately as they may have had different starting odds. However, as a simplifying assumption, the starting price may be used as the original odds for everyone. Then whenever the odds provider sends the latest in-play odds the bank values for each option may be updated based on the current odds at that time (typically every 2-3 seconds). In a similar fashion to the pre-play odds the odds are selected from a number of sources based on the best available odds (total probability closest to 1).

Bank values always start at 10 for all options. This is because the odds would be the same at the start and this is effectively the user getting their stake back. Note that bank is lower than the range of starting points (11 to 500). Then as an outcome gets more likely, the bank value approaches the original points value. So if the original points were 30 then bank should go from 10 to max 29 (30−1), during the duration of the match. Bank would never actually hit 30. On the other hand, if the outcome gets less likely, the bank value approaches but never reaches 0. So effectively it goes from 10 to min 1 during the match. Of course it can zigzag all over the place, but it will always start at 10 and range from 1 to (original points −1).

All odds will be subjected to a delay while new prices are determined, typically a market will be ‘suspended’ by the odds provider. All providers have a different ‘refresh rate’ (i.e. the time it takes them to re-calculate odds). If one market is suspended, for example the market with the best odds, the system does not merely look for the next available market with the best odds, as that market may not have been refreshed and is still showing outdated odds. Instead, the system waits for the same market to be repopulated and shows ‘suspended’ on the client until this occurs (typically 30 sec-2 mins). The system then uses the last prices for this market to disregard any odds providers prices which have not been updated e.g if they are within 5% of the ‘best odds’ before the suspend state occurred.

A variation on the traditional bank algorithm may be to offer “continuous banking”. In this scenario, if a user banks for more than 10, then the difference above 10 is guaranteed as points. However, the user then has the option to effectively bet that 10 again in that specific event. This would then be bankable again, and likewise if the bank value goes above 10 again, then another banking opportunity is created. So effectively it is continuous banking during inplay. The user can choose not to bank (and see the match through as before) or bank below 10, in which case those points are guaranteed, but no new betting opportunity has been created.

The second option for handling inplay odds is permitting users to change their odds and selections during inplay. As above, bank values may be used to calculate the points. And the losing options would start at 10 and migrate towards 1 during the match. However the key difference here is on the winning option. There are two opposing forces, the first causes the points to go higher towards original odds, the more likely the outcome. The other force pulls in the opposite direction as time passes by introducing a decay curve. So effectively this option also ends up towards 1 by the end of the match. For bank to be available a provider must offer odds for the event. If no provider offers odds the system would not offer bank for that event. This may happen for less popular sports. It is, however, possible to introduce a version of bank based on the score feed—where the odds could be automatically increased/decreased if a team is winning/losing (and based on other match data).

### Pools

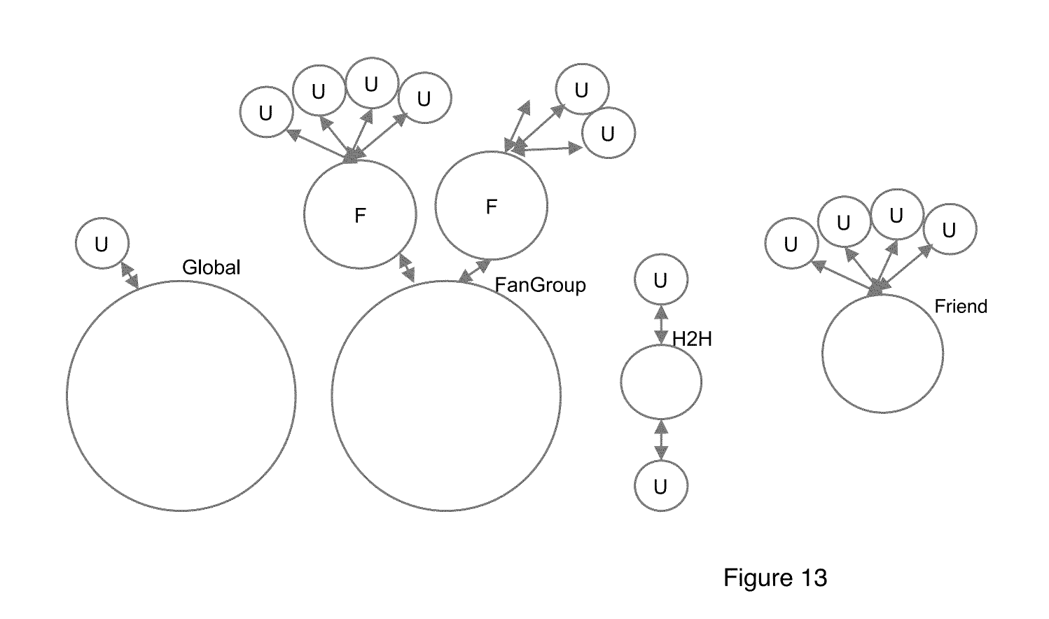

The game mechanics and scoring are completely independent of the pools. There may be one pool, several separate pools, or combined pools as shown in FIG. 13 (where U represents a user, F represents a Fangroup, and H2H represents Head to Head). Users can decide what pools to put each of their entries, and they can have the same or potentially different entries for each pool. The purpose of the pool is to compete with other users so as to win the pot. The different pools are explained below:
1. Head to Head: this is simply putting a user against one other user. The highest score wins (ties are split in all pools).
2. Global (or public): this is the pool that comprises everyone's entries. The top 10% highest scores win the pot. This % is configurable and the system utilises a sliding scale of distributions.
3. Friend (or private): this is a user configured pool where users are invited into a closed, private pool. For purposes of simplification the size of the private pool may be limited, for example, to 100 users, and the highest score is rewarded.

The first two pools may be defined automatically, while the friend pool may require set-up on the part of the user (adding friends, for example). The stake for each pool may be fixed to IP$10. Fixing of the stake may be simpler, but different stake levels and different currencies can be envisaged.

A fourth, new pool betting type may also be provided. This is a pool of pools or group betting. Users are organized into groups, this may be manual or automatic. For example, in the world of sports, the fangroup is the most natural and obvious way to organize. Before entering the first game in a given competition, the system queries users which fangroup they support. The options are one of the runners in the competition (all or a subset). Example fangroups include:
Manchester United
Andy Murray
San Francisco 49ers
American Idol Contestant 1
Nasdaq Index

Once chosen, the user maintains this fangroup throughout the competition. Then all users with the same fangroup are grouped together. And they effectively have one entry into the pool. The amount of the pool is IP$10 multiplied by the total number of entries. The total number of entries will equal the total number of users in each of the fangroups (the system may check to see that there are a minimum number of users to qualify a fangroup, to keep things fair and interesting).

Then, the system determines points for each fangroup entry by taking the fangroup with the least number of users, for example, X. Then taking the top X scores for each fangroup and calculating the average (mean). The fangroup with the highest average wins. The pot is then evenly distributed amongst all users in that fangroup.

While this might seem not to work and favour either the very small or very big fangroups, in practice it actually does work. If a fangroup has substantially more users than one that has very few, then because it has so many more entries (or chances) to get its top picks, it should win more often. However, because it has so many users, the pot has to be divided by a large number of users, with each person's share being relatively small. On the other hand, the smaller fangroup is less likely to win, but each user will get a bigger share of the pot, should they win. Theoretically over a very large number of games, this should balance out and be fair, with no inherent advantage to any user or fangroup.

There are also several possible variations. The system may be defined to always choose a certain number of users (fix X to say 10 and enforce at least that many users required for that fangroup to be active in the pool). The system may be defined to set X to 1 which effectively is the top entry in each fangroup competing for their team. The system may be defined to distribute the pot so those who contributed (by having their entries used in the average calculation) getting more than those who didn't contribute. Alternatively, a sliding scale of distribution could be used, and so forth. The key idea is that the group has an entry in the pool, points are calculated for that group ticket, and the group shares the proceedings if they win.

### Game Process

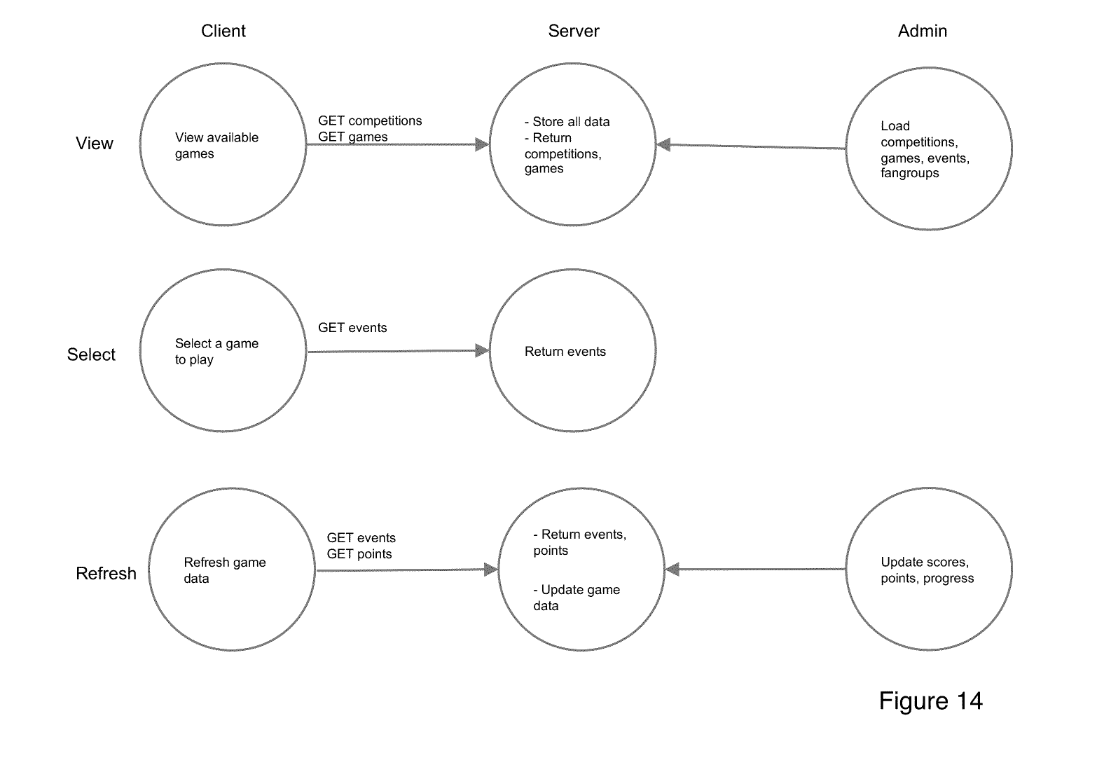

FIGS. 14 to 17 illustrate the game process performed by the system.

### Stage 1

FIG. 14 outlines the initial stages of how real-time sports data is retrieved and loaded onto the client.

### Data Required for the Game

### Schedule

can be few hours in advance (golf) or a few week in advance (football) of event starting
start/end time/date
team name(s)
supplementary info (location, timezone etc.)
Updated every hour (for start time/date)

### In-Play Data

typically much slower than odds
updated every 10-30 seconds (part of the criteria for selecting the best odds could be the speed at which they are refreshed)
Includes data such as scores, elapsed time, game stats

### In-Play Odds

updated every three seconds

### Pre-Play Odds

updated every hour

### Procedure to Load New Games/Competitions as Shown in FIG. 14

Load competitions: e.g. Premier League
Load fangroups: e.g Man u
Load game: e.g. Week 1
   set stake (normally $10, can change based on stage of competition and number of events)
   set start/end date (based on start/end time of events for each game) Load events: e.g. A v B
   each event is linked to a game and competition

The grouping of events for a game is manual and requires a certain degree of operator knowledge of the sport. Typically the events are grouped by week, round or stage of a competition. The system may also group more than one market type into a single game. For example match odds and set winner for tennis. Where each set would have its own market (max of 5 markets as tennis has a max of 5 sets). If the market is not available (typically only the next set would be offered at any one time for tennis) the set may be predefined with default odds of 10 (as above). If the market becomes available the market is automatically added to the database and odds are updated. If the user made a selection of 10 (i.e. picked the team they thought would win with no odds) their selection is automatically updated when the event goes inplay if they have not already updated their points beforehand.

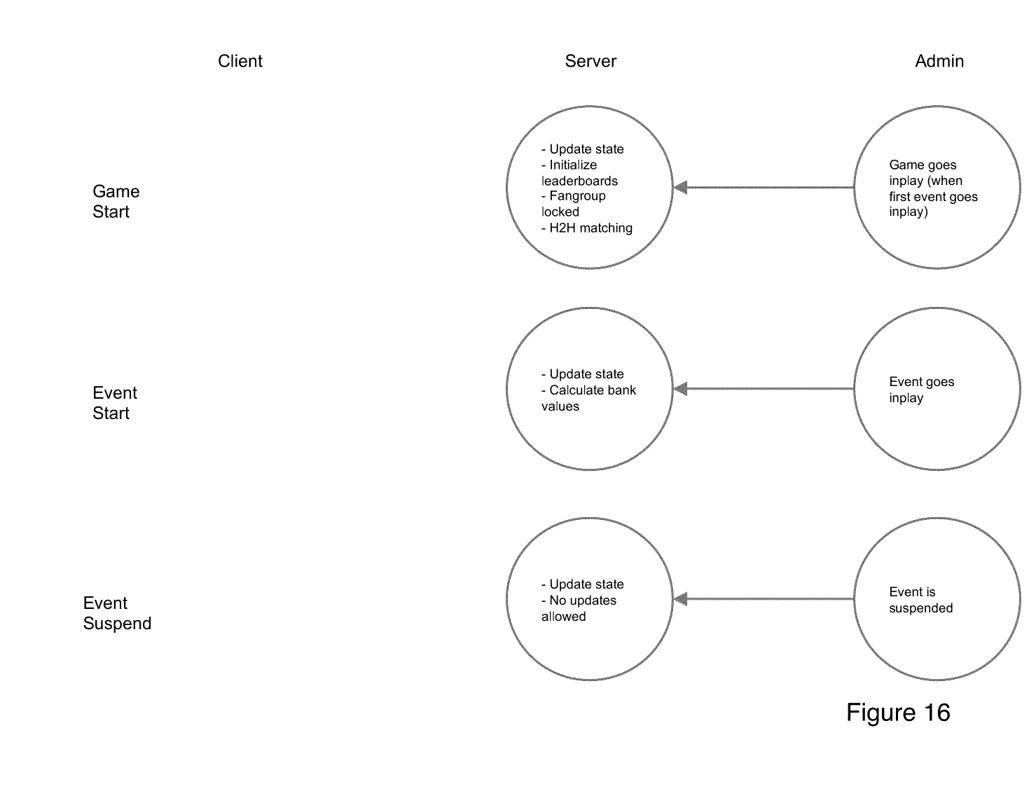

FIG. 16 outlines the administration tasks performed when a game/event/comp goes in-play.
1) When any event goes in-play the entire game is started. The game is not triggered to start on a timer, but based on the real-time score feed. This improves accuracy as the start times for most events are subject to change.

If this is the first event to start in its competition the competition is started and the fangroup selection is locked. The user can not change fangroups for the remainder of the competition.

The points for the in-play event are changed to the bank value, all other events remain pre-play until they individually start.

For live betting events (tennis set betting, next to score etc) each event is started as they occur in real time. For example, Set 1 starts with set odds, Set 2 after Set 1.
2) Users are matched against each other in the H2H pool. H2H matching occurs based on the following criteria

First preference: Users who are in different fangroups

Second preference: If the total number of players in each fangroup is not equal remaining players are matched regardless of group.

### OR—

Second preference: If the total number of players in each fangroup is not equal remaining players are matched against a bot in a different fangroup whose selection is randomly generated.

Third preference: If the number of entries is uneven and one user remains the user is matched against a bot whose selection is randomly generated.

For late entries users are matched at the end of each event based on the above criteria.
3) If an action occurs which requires the odds to be recalculated the event is suspended and no actions are registered on the client until new odds are received (see above for more info on suspend). The lag between the odds feed and a real event occurring is not certain. The event may or may not be watched directly by the odds provider, and delays in TV transmission can affect the refresh time of the odds. Typically an odds provider will have an ‘in-play delay’, this is not normally shown to the user and it can be between 5 and 30 seconds before the user's bet is accepted. To ensure users are not able to bank incorrect odds before the system receives a refresh there is a 30 second timer for bank, which is shown on the client to the user. If the event is not suspended during this period the user is awarded the points they saw when they clicked bank on the client. If the game is suspended an error is returned to the user and the bank is not accepted.

FIG. 17 outlines the administration tasks performed when a game/event/comp is completed.

When an event is completed it is set to a transition state while points are being calculated. Points are awarded to each user if they picked the winning runner.

The results of an event can be as follows
1—True, user gets points
2—False, user does not get points
3—True, users made the correct selection, but does not receive points as they banked (receive the banked points instead)
4—False, user made the incorrect selection but banked and will receive the banked points
5—Dead heat, runner did not complete (stages comps)
6—No winner, runner did not start, cancelled etc.

When no winner is declared and the outcome of the event can not be attributed to the performance of the runner (match cancelled etc) the game stake is returned to all users.

Winnings are calculated when each event is completed, when the last event is complete the final winnings are calculated and added to the leaderboard tables.

A potential advantage of some embodiments of the present invention is that points are determined by probabilities (odds), making predictions substantially more interesting and dynamic; points may be updated throughout pre-play and in-play and reflect current true probabilities, which allows users to update current points, change selections, or bank a selection in-play; over a large number of events, each user may have a theoretical equal chance of winning no matter their selections, meaning everyone is in the game and anyone can potentially win; and different types of pool play are possible, including global (public), friend (private), head to head, and a pool of pools, which increases player enjoyment.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A computer-implemented method of providing a game within a communications network comprising a plurality of devices and at least one server, including the steps of:
a) at least one player of a plurality of players within a pool selecting an outcome for an event at a device;
b) the server accumulating points for the player, wherein the points are calculated based upon odds for the outcome at the time of selection; and
c) the server determining the winning player or players for the pool based upon accumulated points.

2. A method as claimed in claim 1, wherein the odds change over a time period, and the player selects the outcome during the time period.

3. A method as claimed in claim 2, wherein the time period includes, at least, a portion of the event time.

4. A method as claimed in claim 2, including the step of the player changing their outcome selection during the time period.

5. A method as claimed in claim 4, wherein, when the player changes their outcome selection, the player accumulates points which are calculated based upon the difference in odds between initially selected result at the time of selection and the new result at the time of changed selection.

6. A method as claimed in claim 2, including the step of the player banking their outcome selection during the time period.

7. A method as claimed in claim 6, wherein, when the player banks their outcome selection, the player accumulates points which are calculated based upon the difference in odds at the time of selection and the time of banking.

8. A method as claimed in claim 1, wherein one or more players select outcomes across a plurality of events.

9. A method as claimed in claim 8, wherein a winner or winners for the plurality of events is determined based upon points

10. A method as claimed in claim 1, wherein the outcomes are selected from a plurality of options.

11. A method as claimed in claim 1, wherein the odds for the outcome are normalised from odds compiled using an overround.

12. A method as claimed in claim 1, wherein the odds for the outcome are calculated based upon a plurality of odds for the result.

13. A method as claimed in claim 1, wherein the player accumulates points if the selected outcome occurs.

14. A method as claimed in claim 1, wherein the device displays a plurality of outcomes for one or more events and possible points to accumulate in relation to each outcome prior to selection of an outcome by the player.

15. A method as claimed in claim 14, wherein the odds change over a time period, and the player selects the outcome during the time period and wherein the device displays possible points changing over time in response to the change in odds.

16. A method as claimed in claim 14, wherein one or more players select outcomes across a plurality of events and wherein a single action at the device from the player confirms selection of the plurality of outcomes.

17. A method as claimed in claim 3, wherein, when the selection of the outcome is made during the portion of event time, the points are calculated based upon the odds utilising a decay function such that the points decrease during the portion of event time.

18. A method as claimed in claim 1, wherein the player is allocated to the pool automatically.

19. A computer-implemented method of providing a game within a communications network comprising a plurality of devices and a server, including the steps of:
a) each player of a plurality of players within one of a plurality of pools selecting an outcome for an event at a device;
b) the server accumulating points for each player based upon their selection;
c) the server totalling the points for a selection of players within each pool; and
d) the server allocating winnings across the pool with the largest points total for the selection.

20. A method as claimed in claim 19, wherein the selection of players is determined based upon the players with the most points within the pool.

21. A method as claimed in claim 19, wherein the total number of player selected is the total number of players within the smallest pool.

22. A method as claimed in claim 19, wherein the winnings are evenly allocated across the pool.

23. A system for providing a game, including:
a plurality of devices;
one or more servers; and
a communications network;
wherein the system is configured for providing the method of claim 1.

24. A device configured for use with the system of claim 23.

25. A computer readable storage medium having stored therein instructions, which when executed by a processor of a device with a touch screen display cause the device to perform the method of claim 1.

26. A system for providing a game, including:
a plurality of devices;
one or more servers; and
a communications network;
wherein the system is configured for providing the method of claim 19.

27. A device configured for use with the system of claim 26.

28. A computer readable storage medium having stored therein instructions, which when executed by a processor of a device with a touch screen display cause the device to perform the method of claim 19.
